(19) United States
(12) Patent Application Publication
(10) Pub. No.: US 2023/0240194 A1
(43) Pub. Date: Aug. 3, 2023

(54) PATTERN LAYER TO BE ADHERED TO LIVING BODY

(71) Applicant: Yuto Izawa, Koganeishi (JP)

(72) Inventor: Yuto Izawa, Koganeishi (JP)

(21) Appl. No.: 18/011,130

(22) PCT Filed: Jul. 6, 2021
(86) PCT No.: PCT/JP2021/025532

§ 371 Date: Dec. 16, 2022

(30) Foreign Application Priority Data
Jul. 6, 2020 (JP) 2020-116736

(51) Int. Cl. A01G 7/00; B44C 5/06

(52) U.S. Cl. CPC A01G 7/00; B44C 5/06

(57) ABSTRACT

In some embodiments, this disclosure provides a method for creating a design layer to adhere to a living body, said method comprising:
drawing a design on a surface layer by placing a dye on the surface layer in advance; and placing an adhesive layer thereon; and
adhering the dye so that it is sandwiched between the surface layer and the adhesive layer.

### FIELD

This application relates to a design layer to adhere to a living body.

### BACKGROUND

### Description of the Related Art

Patent document 1 discloses a technique for gift-use ikebana that is formed on a die-cut stencil sheet, and the design is drawn by pressing the stencil sheet against the petals and placing cosmetic powder to the die-cut area.

Patent document 1: JP2010006035

In the printing method of Patent Document 1, the ink adheres directly to the surface of the living body. However, once the ink adheres to the biological surface, it is absorbed by the organism, and the design gradually disappears. Therefore, the clarity of the printed design is not maintained. It is necessary to develop a design layer that is constructed so that the ink is not absorbed by the living body.

### SUMMARY

This disclosure provides a design layer adhering to a living body having a surface layer and an adhesive layer, said adhesive layer having a function of adhering to a surface of a living body, a dye with a design adhered thereto sandwiched between the said surface layer and said adhesive layer. And the adhesive layer has a property of not allowing the dye to penetrate. In this embodiment, the dye depicting the design adheres so that it is sandwiched between the said surface layer and said adhesive layer. Since the said adhesive layer does not allow the said dye to penetrate, the dye is prevented from being absorbed by the living body. The adhesive layer is impervious to the dye, thus preventing the dye from being absorbed by the living body.

Further features and advantages of the design layer adhered to the living body will become clear from the following description of embodiments.

### BRIEF DESCRIPTION OF THE DRAWINGS

### Detailed Description of Preferred Embodiments

This section describes the embodiment of a design layer to adhere to an organism. Here, a plant (including petals, leaves, stems, and fruits) is taken as an embodiment of an organism. However, the effects of this disclosure are not limited to plants. However, the effects in the disclosure are not limited to plants but can be demonstrated on any living organism.

The design layer adhered to the living body has a surface layer and an adhesive layer. The adhesive layer is the layer adhered to the living body, and the surface layer is the outer layer viewed from the living body when the design layer adheres to the living body. In the disclosure, the physical properties of the surface layer are not limited. Since the dye depicting the design adheres so that it is sandwiched between the surface layer and the adhesive layer, it is suitable if the surface layer has a certain degree of transparency in order for the design to be visible to a person. The color of the surface layer can be either colorless or colored. It is also suitable to include fine particles in the surface layer to create a surface layer that reflects light and provides an aesthetic effect. Examples of surface layer materials include synthetic fibers and synthetic resins, such as urethane, acrylic, silicone, rubber, and sheets of polysaccharides that humans can eat. In other words, the dye can be made of edible materials, and the entire design layer attached to the living body can be made of edible materials.

The adhesive layer is characterized by properties that do not allow the dye to penetrate. As an example, it is suitable if the adhesive layer is of a nature that does not allow water or oil to penetrate. The polymerized structure may be so fine that water or oil molecules cannot penetrate it. The polymerized structure can be made of organic material or synthetic resin, for example. In this way, oil and water secreted from the living body do not penetrate the adhesive layer, and the dye does not penetrate into the adhesive layer, so the dye does not penetrate the adhesive layer and moves to the living body to be absorbed. In the disclosure, the adhesive layer is sufficient to achieve the effect that the dye does not penetrate. In other words, the adhesive layer is not limited to the synthetic resin described above but is characterized by being composed of densely packed molecules so as not to allow the dye to penetrate, as long as this is consistent with the purpose of the disclosure. The material of the adhesive layer may be synthetic fiber or organic material that humans can eat. As an example of an organic material that humans can eat, polymerized polysaccharide sheets are suitable. Or, as another example, if the adhesive layer is made of a material that does not dissolve the dye, it is possible to prevent the dye from permeating into the adhesive layer. For example, it may be useful to serve the purpose of the disclosure if one of the dyes and the adhesive layer is hydrophilic and one of them is hydrophobic.

The adhesive layer has the property of being able to adhere to the living body. Therefore, as an example, it is suitable if the adhesive layer contains glue that can adhere to the living body.

A dye with a design adheres so that it is sandwiched between the surface layer and the adhesive layer. In one of the many embodiments, it is suitable drawing a design on a surface layer by placing a dye on the surface layer in advance and placing an adhesive layer thereon and adhering the dye so that it is sandwiched between the surface layer and the adhesive layer. As another embodiment, it is suitable drawing a design on an adhesive layer by placing a dye on the adhesive layer in advance and placing a surface layer thereon and adhering the dye so that it is sandwiched between the surface layer and the adhesive layer. As another embodiment, a substance other than the dye may be sandwiched between the surface layer and the adhesive layer. For example, by inserting a light-reflecting substance between the surface layer and the adhesive layer, a design layer can be constructed that reflects light and improves the aesthetic appeal of the surface layer.

The adhesive layer can also be characterized as a light-transmitting material. One example is a material that is colorless and transparent. Examples of materials include synthetic resins and thin sheets made of polysaccharides. The adhesive layer is not limited to the above examples but can be composed of a mixture of light-transmitting molecules as long as it is consistent with the purpose of this disclosure.

It is also suitable if the adhesive layer is characterized by a substance that does not transmit light. For example, mixing white molecules in the adhesive layer is suitable. In this way, the light will be reflected in the adhesive layer, and the adhesive layer will not transmit light. The adhesive layer is not limited to the white example and can be composed of a mixture of molecules that do not transmit light as long as it is consistent with the purpose of this disclosure. For example, it can be other dyes, or it can contain a material that reflects all visible light.

The composition disclosed in each of the above embodiments can be applied in combination with the composition disclosed in other embodiments as long as there is no contradiction. With respect to other configurations as well, the embodiments disclosed herein are in all respects merely illustrative. Therefore, various modifications can be made as appropriate within the scope that does not depart from the purpose of the disclosure. As a method of drawing a design by placing a dye to a surface layer, an image may be drawn on the surface layer by placing a dye on the surface layer using a printer.

In a embodiment, it is suitable adhering to the design layer to a plant. Plants need to be watered in order to survive. In other words, when printing on a plant surface, the printed surface gets wet in the process of watering the plant. In conventional technology, the printed dye is exposed. In other words, in conventional technology, the ink printed on the plant is wetted by water and leaks out. If this happens, the printed pattern may be destroyed, and it may be difficult to maintain the printing. If the dye was exposed, not only water but also physical contacts, such as human contact or insect contact, could cause dye particles to be removed from the plant surface.

The embodiment has a surface layer and an adhesive layer, wherein said adhesive layer has the function of bonding to a biological surface, and the dye with a pattern adheres so that the dye is sandwiched between the said surface layer and said adhesive layer, thereby preventing the dye molecules from being detached from the design layer due to contact of a substance to the dye.

The surface layer is suitable if it is hydrophobic. The hydrophobic nature of the surface layer prevents the dye molecules from coming into contact with water and peeling off from the design layer, even if the design layer is wetted with water. It is suitable if the surface layer is adhered by covering the entire dye so that the surface layer sandwiches the patterned dye between the surface layer and the adhesive layer. In this way, it is possible to prevent the dye molecules from peeling off from the design layer due to the contact of a substance with the dye.

The following is an overview of the design layer adhered to the living body as described above.

A design layer adhering to a living body having a surface layer and an adhesive layer, said adhesive layer having a function of adhering to a surface of a living body, a dye with a design adhered thereto sandwiched between the said surface layer and said adhesive layer, and said adhesive layer having a property of not allowing said dye to penetrate.

In this configuration, since the adhesive layer is of a nature that does not allow the dye to penetrate, the dye can be prevented from being absorbed into the living body. Therefore, the dye with a pattern adheres so that it is sandwiched between the surface layer and the adhesive layer, and its position is kept protected so that the clarity of the pattern is maintained. Furthermore, since the patterned dye is covered by the surface layer, the dye molecules are prevented from peeling off from the design layer due to contact with substances with the dye. Therefore, the clarity of the design is maintained.

The adhesive layer is suitable if it is characterized by being a light-transmitting material. In this configuration, the adhesive layer transmits light, so the color of the organism to which it is attached is reflected. Therefore, when the design layer adheres to the plant, the color of the organism is projected on the background of the design depending on the color of the plant to which it is attached, creating diversity in the design and improving its aesthetic appeal. The same effect is achieved not only for plants but also for all living organisms.

The adhesive layer is suitable if it is characterized by the fact that it is a substance that does not allow light to penetrate.

In this configuration, the adhesive layer does not transmit light, so the color of the organism to which it is attached is not reflected and visible. Therefore, this configuration is suitable for cases where mixing the color of the pattern and the color of the living body interferes with the directional effect of the pattern. One example is the case where the design layer is adhered to a red rose using a human face photograph as the design. If the adhesive layer is permeable to light, the red color of the rose will be transparent through the human face photo, making the skin color of the person appear red, which will interfere with the effect of the design. By mixing white molecules in the adhesive layer, for example, the light does not penetrate through the adhesive layer, and the design can accurately show the original skin color of the person, thus greatly improving the aesthetics of the design. The same effect can be achieved not only on plants but also on all living organisms.

The living organism is suitable if it is a plant.

In this configuration, the dye with the design is not absorbed by the surface of the plant, so the pattern persists on the plant for a long time. Plants have the advantage that the design layer is less likely to peel off compared to other living organisms that are in motion.

Therefore, it is possible to improve the aesthetics of plants and create plant-derived products that combine plants with literature, art, and media. In addition, if all of the design layers are made of edible materials, the plants can be eaten as fruits and vegetables, thus reducing the waste of stickers attached to food products.

The design layer attached to the living body, according to the disclosure, should be able to produce at least one of the above-mentioned effects.

The following other embodiments are also possible.

A method of advertising, wherein designs, images, or text requested by an advertiser as advertising content, said method comprising:

acquiring the advertising content from the advertiser; and

At least one of following steps: creating an advertising plant by printing the advertising content on a sheet having an adhesive layer and attaching the sheet to a plant; or creating an advertising plant by printing the advertising content on a plant surface; and

exhibiting the advertising plant.

Alternatively, the following embodiments can be taken. A method of advertising, wherein designs, images, or text requested by an advertiser as advertising content, said method comprising:

Acquiring the advertising content in electronic data from the advertiser; and

Creating a processed data by enlarging or reducing the electronic data so that it becomes smaller than the surface area size of a plant to be printed; and

At least one of following steps: creating an advertising plant by printing the processed data on a sheet having an adhesive layer and attaching the sheet to a plant; or creating an advertising plant by printing the processed data on a plant surface; and

exhibiting the advertising plant.

The above advertising method has a step of creating an advertising plant by adopting one or more of the following: a creation step of creating an advertising plant by printing said advertising content on a sheet having an adhesive layer and attaching said sheet to a plant, or a creation step of creating an advertising plant by printing said advertising content on a plant surface. It means that the advertisement plant is made by adopting one or more of the following steps.

In advertising by plant, the advertising content is received from the advertiser in electronic data. The content may be a design, an image, text, or a combination. For example, a trademark or logo owned by the advertiser is considered a design. For example, it could be an image of an actor used by the advertiser, an image of the product being advertised, or a still image of a portion of a commercial broadcast on television. Or, it could be a tagline or catchphrase created by the advertiser. It can be a combination of these or data that the advertiser has asked a designer to combine to create a unique spatial arrangement. In other words, the advertiser receives whatever content he or she desires in electronic form. An advertiser is a person or organization that wants an unspecified number of people to recognize a particular design, image, text, or combination thereof. The content of an advertisement is a specific design, image, text, or combination of designs, images, or text that is intended to be recognized by an unspecified number of people. For example, it could be a corporate logo, an Olympic emblem, or a character or person from an animated cartoon or movie. It could be a tax advisory text issued by a local government. An advertising is in the business of making an unspecified number of people aware of the advertiser's desired advertising content. A botanical advertisement or advertising plant is a plant that has the function of an advertising.

The electronic data receiving part can consist of a program that receives data via the Internet, a nonvolatile memory that holds the program, and a CPU that executes the program and performs various arithmetic operations. Alternatively, it can be composed of a USB memory device, a USB hub, a program that receives data, and a CPU that executes the program and performs various arithmetic operations. In recent years, smartphone applications have had the ability to communicate data. Therefore, the system can be composed of the aforementioned application for receiving and transmitting advertising data that runs on a smartphone. The data processing section is configured as a step to receive data using these applications and hardware.

The data processing section creates processed data by enlarging or reducing the acquired electronic data of the advertising content to a size smaller than the size of the plant surface to which the design layer is attached. The size of the plant surface to which the design layer is attached is measured in advance. For example, if the target is a flower petal with a size equivalent to a circle with a diameter of 3 cm, the electronic data of the acquired advertisement content should be processed by cutting an area from the data so that the size is equivalent to a circle with a diameter of 3 cm. Alternatively, the processed data may be the electronic data that has been vertically or horizontally enlarged or reduced so that it fits within the 3 cm diameter circle. The data processing section can be composed of a program to perform the relevant functions, a nonvolatile memory that holds the program, and a CPU that executes the program and performs various arithmetic operations.

The data processing part can be composed of a program to perform the relevant functions, a nonvolatile memory that holds the program, and a CPU that executes the program and performs various arithmetic operations. The data processing unit can be configured as a smartphone application that intuitively cuts the outline of an image by simply operating a finger. This can be configured as a step to process data using these applications or hardware.

The step of creating an advertising plant by printing the advertising content on a sheet having an adhesive layer and attaching the said sheet to the plant can be realized by using the design layer that is attached to the living body as described above. The step of creating an advertising plant by printing said advertising content on the surface of the plant could be realized, for example, by using a printer to print an image on the surface of the plant by placing the plant in place of paper and activating the printer, as if printing on paper. The data processing step of creating processed data by enlarging or reducing the acquired electronic data so that it becomes smaller than the surface area size of the plant to be printed can be realized by using a computer to resize the electronic data of the contents to be printed and output the processed data to a printer.

The printing section, which prints the processed data on the surface of the plant, is described below. The plant is fixed with metal fittings or adhesive tape, and the processed data is printed on the surface. For example, if the target is a petal with a size equivalent to a circle with a diameter of 3 cm, the processed data is processed to a size equivalent to a circle with a diameter of 3 cm, so the processed data, which is approximately the same size as the plant surface, can be printed by inkjet or ink application. The printing department consists of pad printers and offset printers connected via the Internet to the data processing department. A mold of the advertisement content can also be created, and then powder pigments or metallic powders can be applied to match the mold. This step consists of printing the processing data on the surface of the plant using these applications and hardware. On a pad press, an intaglio plate that simulates the advertising content is used to transfer the ink on the plate to a silicone pad for primary transfer to the substrate for secondary transfer. In the case of an offset press, a plate that imitates the advertisement is made, and ink, once applied to the plate, is transferred to a rubber bracket before being printed on the plant surface.

The data acquisition, data processing, and printing sections can be composed of a program for performing the relevant functions, a nonvolatile memory that holds the program, and a CPU that executes the program and performs various arithmetic operations. Each of the embodiments described herein can be realized not only as a device but also in part or in whole as a method. In addition, a portion of such devices can be configured as software. Furthermore, software products used to execute such software on a computer and recording media on which such products are fixed are naturally included in the technical scope of each embodiment described herein (the same is true throughout this specification).

The data acquisition, data processing, and printing sections may be differentially operated as a unified program that is connected via the Internet and operates automatically. According to this configuration, once the advertisement content is received from the advertiser, the advertisement plant is automatically created by simply running the program, thereby creating the effect of an efficient plant-based advertising business. This disclosure provides a completely new plant advertisement creation device and method that is different from conventional advertisement agency methods and devices.

The plant in this embodiment has its leaves, petals, stems, fruits, and other surfaces decorated with a design, such as a corporate logo or other text, such as a catch copy devised by the advertiser. Plant advertisements are plants on which the content of the advertisement is printed and which are displayed. Since these plant advertisements are displayed, they are visible to a large number of people and are very effective as an advertising proxy. When people see botanical advertisements, they receive a positive impression of the vitality and loveliness of the plants and flowers in the advertisements. According to this embodiment, the advertisements have more aesthetic and conceptual features than those printed on paper and exhibited or distributed, and are more appealing and have a remarkable advertising effect.

The location for displaying said botanical advertisements might be a florist's store or a venue where the said florist is in charge of flower arrangement. By doing so, the florist, after creating the plant advertisement, can act as its own advertising without the need for another delivery company to act as an intermediary. This reduces transportation costs and time loss of intermediaries and allows the florist to begin advertising representation more efficiently.

The embodiment provides a completely new method for an advertising that can give the content of advertisements a conceptual quality, such as the vitality and loveliness of plants and flowers. Conventional technology can print advertisements on paper or inorganic materials. However, it is not possible to give the contents of the advertisements the life force and loveliness of plants and flowers. The advertising content can be printed on beautiful flowers and leaves, which increases the aesthetic value of the advertisement.

This advertising method can print images on the surface of beautiful plants, making it possible to create particularly beautiful advertisements. Printing an image on the surface of a plant makes the image look more beautiful and special than printing an image on paper or a computer display screen. This makes it possible to provide an advertising method that is remarkably effective in advertising with images.

The following embodiments can also be used.

A method of advertising, said method comprising:

obtaining a date data which indicates a date when the plant was received; and

obtaining elapsed days to record how many days have elapsed since the date data; and

comparing the elapsed days among plants and selecting a plant which has more elapsed days as a candidate plant for printing; and

printing a advertising content on the candidate plant.

In this advertising method, the date when the plants are received is obtained and recorded.

The method of recording may be done in a notebook or by preparing at least one computer and storing it in its memory. The elapsed date of the plant may be counted in the control unit of at least one computer.

In this advertising method, before the elapsed days elapse and the plants lose their freshness and are discarded, they can be selected as candidate plants for printing, and advertising agencies using the plants can be performed. This reduces the loss of plants that would otherwise be discarded.

Or, the following embodiments can be taken.

The display location in the step of displaying the advertising plant in any one of the above methods of an advertising is also suitable to be characterized as a location where the advertising plant is visible to a large number of unspecified people.

The display location in the step of displaying the advertising plant in any one of the advertising methods described above is also characterized in that it is a location desired by the advertiser.

The display location in the step of displaying the advertising plant in any one of the above-mentioned advertising methods is also suitably characterized in that the display location is a florist's store or a venue where the said florist is in charge of flower arrangement. In this advertising method, the advertising can be effective because a large number of unspecified people will see it. Examples of such places include restaurants and waiting rooms. This method of advertising representation can be effective because an unspecified number of people will see the advertisement at the florist's store or at the venue where the florist is in charge of flower arrangement. In this method of advertising representation, the advertisement is seen by an unspecified number of people and can be effective. Examples of such places include restaurants and waiting rooms.

Plants created by any one of the above methods of advertising should also be protected as patents. A printing device realizing any one of the above methods of advertising should also be protected as a patent.

What is claimed is:

1-5. (canceled)

6. A method for creating a design layer to adhere to a living body, said method comprising:
drawing a design on a surface layer by placing a dye on the surface layer in advance; and
placing an adhesive layer thereon; and
adhering the dye so that it is sandwiched between the surface layer and the adhesive layer.

7. A method for creating a design layer to adhere to a living body, said method comprising:
drawing a design on an adhesive layer by placing a dye on the adhesive layer in advance; and
placing a surface layer thereon; and
adhering the dye so that it is sandwiched between the surface layer and the adhesive layer.

8. A method for creating a plant having a design layer adhered to a living body, said method comprising:
At least one of methods as set forth in claim 6 or claim 7; and
adhering to the design layer to the plant.
